(19) United States
(12) Patent Application Publication
(10) Pub. No.: US 2023/0078802 A1
(43) Pub. Date: Mar. 16, 2023

(54) METHOD AND DEVICE FOR ISSUING MERCHANDISE COUPON USED FOR FOOD ORDERING

(71) Applicant: KOUBEI (SHANGHAI) INFORMATION TECHNOLOGY CO., LTD., Shanghai (CN)

(72) Inventors: Yu WANG, Shanghai (CN); Qingsong HE, Shanghai (CN); Xinmeng WANG, Shanghai (CN); Siyuan CHENG, Shanghai (CN); Xiang HUANG, Shanghai (CN)

(21) Appl. No.: 17/601,698

(22) PCT Filed: Mar. 31, 2020
(86) PCT No.: PCT/CN2020/082482

§ 371 Date: Apr. 12, 2022

(30) Foreign Application Priority Data
Apr. 9, 2019 (CN) 201910281357.4

(51) Int. Cl. G06Q 30/02; G06Q 50/12; G06Q 30/06

(52) U.S. Cl. CPC G06Q 30/0208; G06Q 30/0222; G06Q 50/12; G06Q 30/0633

(57) ABSTRACT

Methods and devices for issuing merchandise coupon of ordering food are disclosed in this application, wherein the method includes: creating a merchandise instance for generating a merchandise coupon, and determining instance food information associated with the merchandise instance according to an obtained candidate food list for the merchandise instance, storing an association between merchandise instance and instance food information as an instance-food association record in a preset merchandise coupon database; creating the merchandise coupon for the merchandise instance; issuing the created merchandise coupon to a user terminal; storing a correspondence between issued merchandise coupon and user terminal receiving the merchandise coupon as a coupon-user association record in the merchandise coupon database, such that, when receiving a food ordering request from the user terminal, performing a cancellation after verification on the issued merchandise coupon according to the coupon-user association record and the instance-food association record stored in the merchandise coupon database.

### CROSS REFERENCE OF RELATED APPLICATIONS

The present application claims priority to Chinese patent application No.2019102813574 entitled “Method and Device for Issuing Merchandise Coupon of Ordering Food” filed with the Chinese Patent Office on Apr. 9, 2019, the entire contents of which are incorporated herein by reference.

### TECHNICAL FIELD

The present disclosure relates to the field of electronic information, and in particular, to a method and device for issuing merchandise coupon of ordering food.

### BACKGROUND

At present, in order to facilitate users and reduce queuing time, many restaurants have opened online-scanning-code ordering services. Users can directly enter restaurant's menu page for ordering operations by scanning table code with their mobile phones. This method saves users' time to go to cashier and wait in line, allowing them to complete ordering while sitting on their seats, and thus enhancing user comfort.

In addition, many users are accustomed to receiving merchandise coupons in advance and choosing restaurants based on received merchandise coupons in App's card package. In the prior art, received merchandise coupons in App's card package are stored in backend database, and are distinguished by unique coupon code identifiers. For using a merchandise coupon, the user needs to show the merchandise coupon to a cashier, and the cashier manually confirms whether the merchandise coupon can be canceled after verification in their restaurant. When confirming that it can be cancelled after verification, the cashier will manually check each food corresponding to the merchandise coupon, performing a cancellation after verification on the merchandise coupon, and then prepare each food corresponding to the merchandise coupon for the user. In addition, if the user needs other food in the restaurant, he/she needs to pay for the other food separately.

The inventor of the present disclosure found that the above-mentioned methods in the prior art have at least the following defects: existing merchandise coupons can only be cancelled after verification by manual check, and the cancellation after verification cannot be automatized; moreover, existing merchandise coupons cannot be used in online-scanning-code ordering service scenarios, and applicable scenarios are limited.

### SUMMARY

In view of the above-mentioned problems, methods and devices for issuing merchandise coupon of ordering food are provided to solve or at least partially solve these problems.

According to an aspect of the present disclosure, a method for issuing merchandise coupon of ordering food is disclosed as including: creating a merchandise instance for generating a merchandise coupon; determining instance food information associated with the merchandise instance according to an obtained candidate food list for the merchandise instance; storing an association between merchandise instance and instance food information as an instance-food association record in a preset merchandise coupon database; creating the merchandise coupon for the merchandise instance; issuing the created merchandise coupon to a user terminal; storing a correspondence between issued merchandise coupon and user terminal receiving the merchandise coupon as a coupon-user association record in the merchandise coupon database, such that, when receiving a food ordering request from the user terminal, a cancellation after verification can be performed on the issued merchandise coupon according to the coupon-user association record and the instance-food association record stored in the merchandise coupon database.

According to another aspect of the present disclosure, a device for issuing merchandise coupon of ordering food is disclosed as including: an instance creating module configured to create a merchandise instance for generating a merchandise coupon; determine instance food information associated with the merchandise instance according to an obtained candidate food list for the merchandise instance; an instance associating module configured to store an association between merchandise instance and instance food information as an instance-food association record in a preset merchandise coupon database; a coupon creating module configured to create the merchandise coupon for the merchandise instance, and issue the created merchandise coupon to a user terminal; a coupon storing module configured to store a correspondence between issued merchandise coupon and user terminal receiving the merchandise coupon as a coupon-user association record in the merchandise coupon database, such that, when receiving a food ordering request from the user terminal, a cancellation after verification can be performed on the issued merchandise coupon according to the coupon-user association record and the instance-food association record stored in the merchandise coupon database.

According to still another aspect of the present disclosure, an electronic device is disclosed as including: a processor, a memory, a communication interface, and a communication bus, wherein the processor, the memory, and the communication interface communicate with each other through the communication bus; the memory is configured to store one or more executable instructions, and the executable instructions cause the processor to execute corresponding operations in the method for issuing merchandise coupon of ordering food as described above.

According to still another aspect of the present disclosure, a non-volatile computer-readable storage medium is disclosed as having at least one executable instruction stored thereon, where the executable instruction causes a processor to execute corresponding operations in the method for issuing merchandise coupon of ordering food as described above.

According to still another aspect of the present disclosure, a computer program product is disclosed as including a computer program stored on a non-volatile computer storage medium.

According to the method and device for issuing merchandise coupon of ordering food disclosed in the present disclosure, on one hand, a merchandise coupon can be created according to a merchandise instance, and an association between merchandise instance and instance food information can be stored as an instance-food association record in a merchandise coupon database; on the other hand, a correspondence between issued merchandise coupon and user terminal receiving merchandise coupon can be stored as a coupon-user association record in the merchandise coupon database. In this way, when a user ordering food, the issued merchandise coupon can be directly cancelled after verification according to the coupon-user association record and the instance-food association record. It can be seen that, in this method, correspondence between merchandise coupons and instance food information as well as correspondences between merchandise coupons and user terminals are recorded in advance in a process of creating the merchandise coupons, so that the merchandise coupons can be automatically cancelled after verification based on the correspondences during the user ordering food by himself/herself, which eliminates tedious operation of manual check and cancellation after verification, combines ordering food and cancellation after verification of merchandise coupon into one process, and simplifies payment process and provides convenience for users.

The above description is only an overview of the technical solutions of the present disclosure. In order to more clearly understand the technical means of the present disclosure, which can be implemented in accordance with the content of the specification, and in order to make the above and other purposes, features and advantages of the present disclosure more obvious and understandable, specific embodiments of the present disclosure are specifically illustrated below.

### BRIEF DESCRIPTION OF THE DRAWINGS

By reading detailed description of preferred embodiments below, various other advantages and benefits will become clear to those of ordinary skilled in the art. The drawings are only used for the purpose of illustrating the preferred embodiments, and are not considered as a limitation to the present disclosure. Also, throughout the drawings, like reference signs are used to indicate like components. In the drawings:

FIG. 1 shows a flow chart of a method for issuing a merchandise coupon of ordering food according to the first embodiment of the present disclosure;

FIG. 2 shows a flowchart of a method for issuing a merchandise coupon of ordering food according to the second embodiment of the present disclosure;

FIG. 3 shows a structural diagram of a device for issuing a merchandise coupon of ordering food according to the third embodiment of the present disclosure;

FIG. 4 shows a schematic structural diagram of an electronic device according to the fifth embodiment of the present disclosure;

FIG. 5 shows a schematic flowchart of creation process of a merchandise instance;

FIG. 6 shows a schematic flowchart of issuance process of a merchandise coupon;

FIG. 7 shows a schematic flowchart of canceling after verifying a merchandise coupon during an ordering process.

### DETAILED DESCRIPTION OF THE EMBODIMENTS

Exemplary embodiments of the present disclosure will be described in more detail below with reference to the accompanying drawings. Although the drawings show the exemplary embodiments of the present disclosure, it should be understood that the present disclosure can be implemented in various forms and should not be limited by the embodiments set forth herein. Rather, these embodiments are provided to enable a more thorough understanding of the present disclosure and to fully convey the scope of the present disclosure to those skilled in the art.

### Embodiment 1

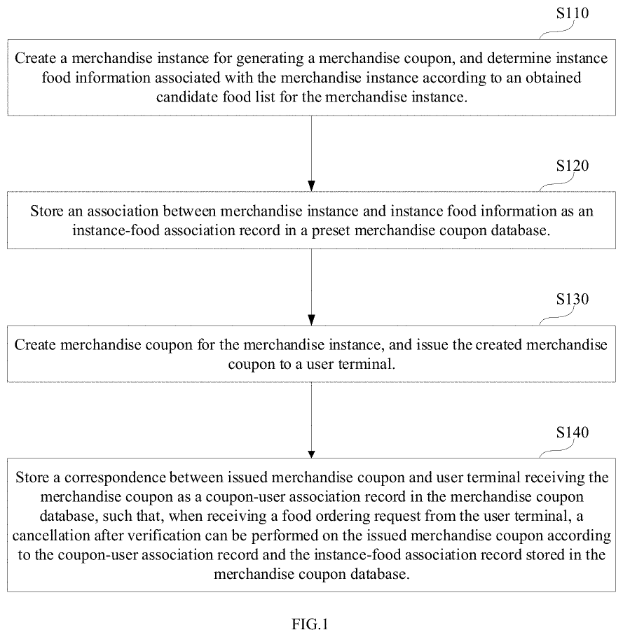

FIG. 1 shows a flowchart of a method for issuing merchandise coupon of ordering food provided by the embodiment 1 of the present disclosure. As shown in FIG. 1, the method includes:

At step S110, create a merchandise instance for generating a merchandise coupon, and determine instance food information associated with the merchandise instance according to an obtained candidate food list for the merchandise instance.

Among them, a merchandise instance refers to entity information of merchandise corresponding to a merchandise coupon, which specifically includes name, specification, quantity, and other information of each merchandise included in the merchandise coupon. The merchandise in the embodiment mainly refers to food. A candidate food list is used to determine each merchandise included in the merchandise instance, in other words, each merchandise included in the merchandise instance originates from the candidate food list. Specifically, the candidate food list may be determined according to a restaurant food list of a restaurant to which the merchandise coupon is applicable. Instance food information associated with the merchandise instance is information of each food specifically included in the merchandise instance.

At step 120: store an association between merchandise instance and instance food information as an instance-food association record in a preset merchandise coupon database.

Among them, there is a fixed correspondence between merchandise instance and its corresponding instance food information. In a preset merchandise coupon database, the association between each merchandise instance and its corresponding instance food information is stored as an instance-food association record, so that a mapping relationship between merchandise instance and instance food information can be bound in a backend database, so as to query the instance food information bound to the certain merchandise instance.

At step 130: create the merchandise coupon for the merchandise instance, and issue the created merchandise coupon to a user terminal.

During a specific creation, the merchandise instance is equivalent to a coupon template. According to the same merchandise instance, multiple merchandise coupons corresponding to the merchandise instance can be created, and a specific number of creation depends on an issued volume of a coupon. Among them, the instance food information corresponding to each merchandise coupon created based on the same merchandise instance is exactly the same.

When issuing the created merchandise coupon to a user terminal, it can be issued through various methods such as free receiving or paid receiving by the user terminal, and the present disclosure does not limit specific issuance method.

At step 140: store a correspondence between issued merchandise coupon and user terminal receiving the merchandise coupon as a coupon-user association record in the merchandise coupon database, such that, when receiving a food ordering request from the user terminal, a cancellation after verification can be performed on the issued merchandise coupon according to the coupon-user association record and the instance-food association record stored in the merchandise coupon database.

Specifically, in this embodiment, every time a merchandise coupon is issued, a correspondence between user terminal receiving the issued merchandise coupon and merchandise coupon is stored as a coupon-user association record in the aforementioned merchandise coupon database. It can be seen that the coupon-user association record and the instance-food association record are stored in the merchandise coupon database. According to the coupon-user association record, each merchandise coupon that a user has received can be obtained, and according to the instance-food association record, the instance food information bound to each merchandise coupon can be obtained, so as to facilitate automatic cancellation after verification of the received merchandise coupon when the user ordering food, thereby combining ordering food and cancellation after verification of merchandise coupon into one process, avoiding tedious operation of manual check and cancellation after verification.

It can be seen that, in this method, correspondence between merchandise coupons and instance food information as well as correspondences between merchandise coupons and user terminals are recorded in advance in a process of creating the merchandise coupons, so that the merchandise coupons can be automatically cancelled after verification based on the correspondences during the user ordering food by himself/herself, which eliminates tedious operation of manual check and cancellation after verification, combines ordering food and cancellation after verification of merchandise coupon into one process, and simplifies payment process and provides convenience for users.

### Embodiment 2

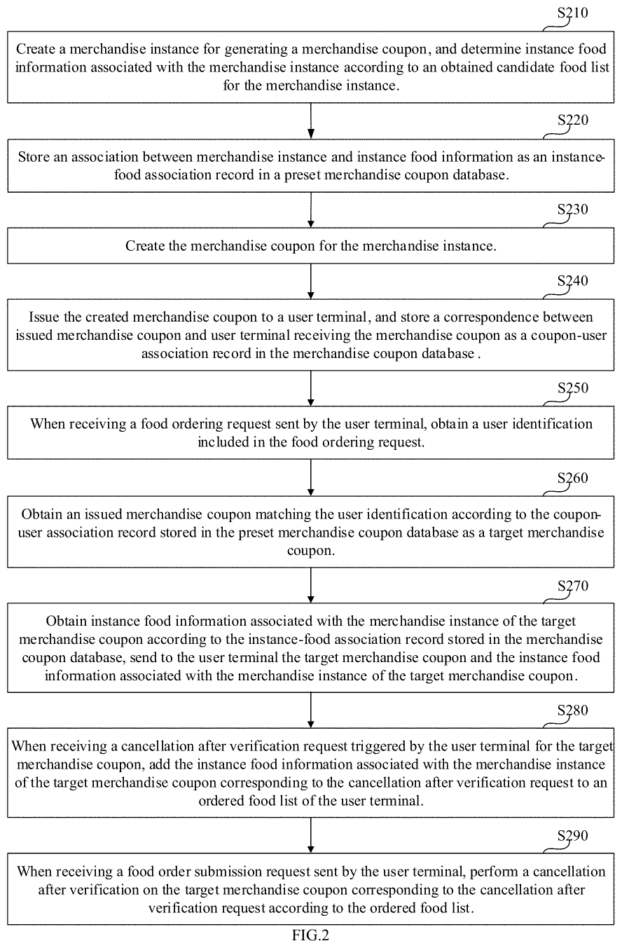

FIG. 2 shows a flowchart of a method for issuing merchandise coupon of ordering food provided by the embodiment 2 of the present disclosure. As shown in FIG. 2, the method includes:

At step 210: create a merchandise instance for generating a merchandise coupon, and determine instance food information associated with the merchandise instance according to an obtained candidate food list for the merchandise instance.

Among them, a merchandise instance refers to entity information of merchandise corresponding to a merchandise coupon, which specifically includes name, specification, quantity, and other information of each merchandise included in the merchandise coupon. The merchandise in the embodiment mainly refers to food. For example, a burger package is a merchandise instance. The merchandise instance includes three food types: burger, fries, and cola. Among them, the burger is a medium chicken burger, the fries are a medium box of fries, and the coke is a medium cup of coke, where “chicken burger”, “ fries”, and “coke” are names of three food types included in the merchandise instance, “medium” is a specification of the food, “a”, “a box”, “a cup” and the like are quantity of the food. It can be seen that one merchandise instance corresponds to one or more foods, and the food corresponding to the merchandise instance is instance food information associated with the merchandise instance. For example, the instance food information associated with the merchandise instance of the aforementioned burger package includes: a medium chicken burger, a medium box of French fries, and a medium cup of coke.

Specifically, when determining the instance food information associated with the merchandise instance, the determination is made according to an obtained candidate food list for the merchandise instance. Among them, the candidate food list for the merchandise instance is usually determined according to a restaurant to which the merchandise instance is applicable. Correspondingly, firstly, determine a target restaurant to which the merchandise instance is applicable; then, according to a restaurant food list of the target restaurant, obtain a candidate food list for the merchandise instance; finally, according to a plurality of target foods selected from the candidate food list, determine the instance food information associated with the merchandise instance. For example, when there are multiple target restaurants to which the merchandise instance is applicable, the restaurant food list of each target restaurant is obtained separately, and according to the restaurant food list of each target restaurant determine the candidate food list for the merchandise instance. Among them, in order to avoid problem that some target restaurants cannot provide foods corresponding to the merchandise instance due to differences between restaurant food lists in multiple target restaurants, in this embodiment, for food lists corresponding to multiple target restaurants, an intersection sub-list between multiple restaurant food lists is obtained, and according to the intersection sub-list determine the candidate food list for the merchandise instance. Since foods in the intersection sub-list are those can be provided by each target restaurant, it is ensured that each restaurant can perform a cancellation after verification on the merchandise coupon for the merchandise instance.

FIG. 5 shows a schematic flowchart of creation process of a merchandise instance. As shown in FIG. 5, at step 1.1, a merchant terminal sends a request to a merchandise system (that is, a merchandise database included in a merchandise coupon database) to create merchandise; at step 1.2, the merchandise system creates merchandise; at step 1.3, the merchandise system returns a notification of successful creation to the merchant terminal; at step 1.4, the merchant terminal sends a request for querying dishes to a dish system (that is, a dish database), and this step is used to obtain a candidate food list; at step 1.5, the dish system returns a query result to the merchant terminal so that a merchant can determine instance food information corresponding to the merchandise instance according to the candidate food list contained in the query result; at step 1.6, the merchant terminal returns a designated dish (that is, the instance food information) associated with the merchandise to the merchandise system; at step 1.7, the merchandise system queries and verifies legitimacy of the designated dishes returned by the merchant according to the dish system, and this step mainly prevents the merchant from entering incorrect instance food information that is not included in the dish system; at step 1.8, the merchandise system records an association between created merchandise instance and its applicable dish information (that is, the instance food information) after the verification is passed; at step 1.9, the merchandise system returns a successful creation result notification to the merchant terminal. Among them, the merchandise system includes the aforementioned merchandise coupon database.

In addition, the merchant can also edit the created merchandise instance to modify a correspondence between merchandise instance and its associated instance food information. It can be seen that, in this embodiment, the instance food information is stored in association with the merchandise instance instead of the merchandise coupon. This method has at least following advantages: since one merchandise instance can correspond to multiple merchandise coupons, therefore, if the instance food information is directly stored in association with the merchandise coupon, once the correspondence between merchandise instance and instance food information needs to be modified, it is necessary to modify each merchandise coupon separately, which is tedious and time-consuming Therefore, in this embodiment, the instance food information is stored in association with the merchandise instance, and the corresponding instance food information can be modified only by modifying the merchandise instance, so that each merchandise coupon for the merchandise instance can be quickly modified in batches.

At step 220: store an association between merchandise instance and instance food information as an instance-food association record in a preset merchandise coupon database.

Among them, there is a fixed correspondence between merchandise instance and its corresponding instance food information. In a preset merchandise coupon database, the association between each merchandise instance and its corresponding instance food information is stored as an instance-food association record, so that a mapping relationship between merchandise instance and instance food information can be bound in a backend database, so as to query the instance food information bound to the certain merchandise instance.

In this embodiment, in order to facilitate management, the merchandise coupon database is further divided into the merchandise database and a coupon database. Accordingly, the association between merchandise instance and instance food information is stored as the instance-food association record in the merchandise database included in the preset merchandise coupon database. Through the merchandise database, it is possible to query the instance food information associated with each merchandise instance that has been created.

At step S230: create the merchandise coupon for the merchandise instance.

During a specific creation, the merchandise instance is equivalent to a coupon template. According to the same merchandise instance, multiple merchandise coupons corresponding to the merchandise instance can be created, and a specific number of creation depends on an issued volume of a coupon. Among them, the instance food information corresponding to each merchandise coupon created based on same merchandise instance is exactly the same. In order to improve creation efficiency of the merchandise coupon, a merchandise coupon template for the merchandise instance is generated in advance, and the merchandise coupon for the merchandise instance is created according to the merchandise coupon template. For example, for the burger package merchandise instance, a burger package merchandise coupon template is generated, which is used to store various coupon information of corresponding merchandise coupon, specifically including denomination data, validity period data, applicable restaurant data, and instance food information and other related data. Correspondingly, based on the merchandise coupon template, the merchandise coupon can be quickly created in batches.

At step S240: issue the created merchandise coupon to a user terminal, and store a correspondence between issued merchandise coupon and user terminal receiving the merchandise coupon as a coupon-user association record in the merchandise coupon database.

Among them, when issuing the created merchandise coupon to the user terminal, it can be issued through various methods such as free receiving or paid receiving by the user terminal, and the present disclosure does not limit specific issuance method. In this embodiment, paid receiving method is taken as an example for description.

Specifically, the created merchandise coupon is added to a merchandise coupon receiving page, and a merchandise coupon receiving entry is added to it. Correspondingly, when receiving a merchandise coupon receiving request which is triggered by the user terminal via the merchandise coupon receiving entry displayed on the merchandise coupon receiving page, generate and send a coupon payment notification message corresponding to the merchandise coupon receiving request; when a coupon payment response message corresponding to the coupon payment notification message is received, issue the merchandise coupon corresponding to the merchandise coupon receiving request to the user terminal. Among them, after a user purchases the merchandise coupon for the merchandise instance online, a coupon system will issue the corresponding merchandise coupon as an electronic voucher for consumption after receiving a notification of the user's successful payment. The user can see the valid electronic voucher that have been issued on his/her own order details page, or on a card package page and other entries.

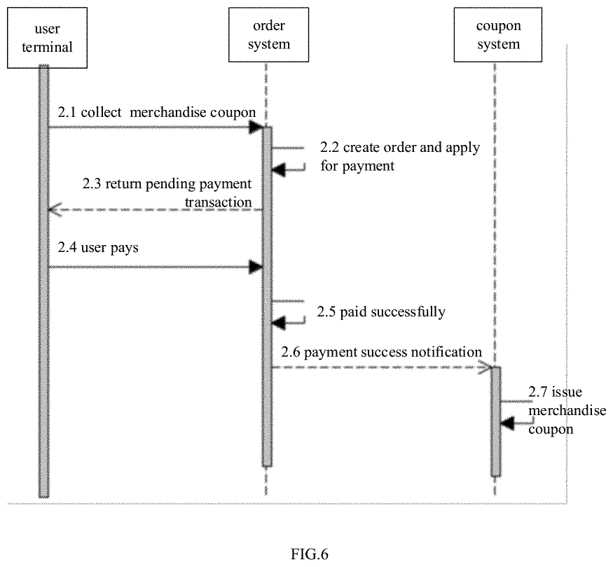

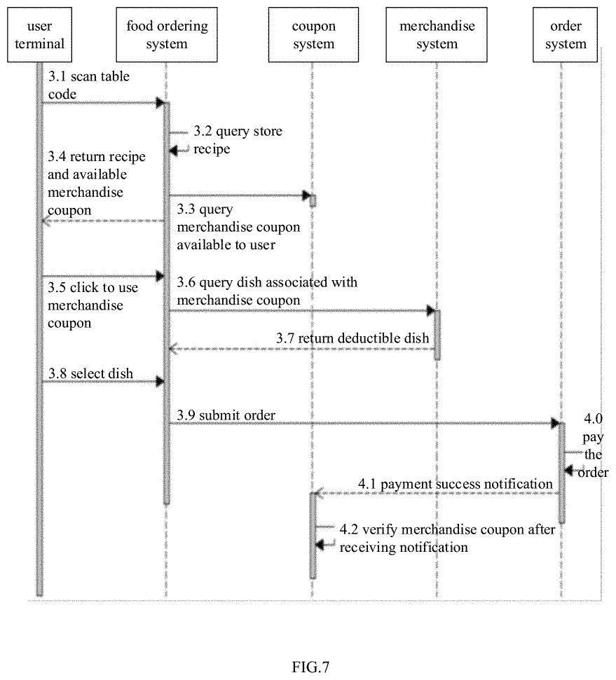

FIG. 6 shows a schematic flowchart of issuance process of a merchandise coupon. As shown in FIG. 6, at step 2.1, the user terminal sends a request to a order system to receive the merchandise coupon; at step 2.2, the order system creates an order corresponding to the merchandise coupon and applies for a user payment; at step 2.3, the order system returns a pending payment transaction to the user terminal; at step 2.4, the user terminal makes payment; at step 2.5, the order system confirms that payment is successful; at step 2.6, the order system sends a payment success notification to the merchandise coupon database (i.e., the coupon system); at step 2.7, the coupon system issues the merchandise coupon to the user according to the received payment success notification.

In this embodiment, after each merchandise coupon is successfully issued, a correspondence between user terminal receiving the issued merchandise coupon and merchandise coupon is stored as a coupon-user association record in the merchandise coupon database. Since the merchandise coupon database in this embodiment further includes the coupon database, correspondingly, a correspondence between issued merchandise coupon and user terminal receiving merchandise coupon is stored as a coupon-user association record in the coupon database included in the merchandise coupon database. By querying the coupon database, it is possible to determine the merchandise coupon that each user terminal has received.

At step S250: When receiving a food ordering request sent by the user terminal, obtain a user identification included in the food ordering request.

Wherein, the food ordering request sent by the user terminal may be a scanning-code ordering request sent by scanning a table code. The scanning-code ordering request includes the user identification corresponding to the user terminal performing code scanning operation, and the user identity performing code scanning operation can be determined according to the user identification. Execution subject of this step may be the food ordering system.

At step S260: Obtain an issued merchandise coupon matching the user identification according to the coupon-user association record stored in the preset merchandise coupon database as a target merchandise coupon.

Specifically, by querying the coupon-user association record stored in the preset merchandise coupon database, the issued merchandise coupons matching the user identification can be obtained. Through this step, it is possible to determine every merchandise coupon that user who performed code scanning operation has already received. Correspondingly, the obtained merchandise coupon is determined as the target merchandise coupon.

In addition, optionally, in order to ensure that the merchandise coupons can be used in the current restaurant, the aforementioned food ordering request further includes a restaurant identification, and the coupon-user association record specifically includes: restaurant information to which respective issued merchandise coupons are applicable and a user identification of user terminal who has received respective merchandise coupons. Accordingly, when the issued merchandise coupon matching the user identification is determined according to the coupon-user association record stored in the preset merchandise coupon database, further, according to the user identification and the restaurant identification included in the food ordering request, the coupon-user association record matching both the user identification and the restaurant identification included in the food ordering request may be selected from the merchandise coupon database. According to the selected coupon-user association record, an issued merchandise coupon matching the user identification may be determined. Through the above method, it is possible to automatically determine, for the user who is ordering by scanning code in the current restaurant, a received merchandise coupon that can be used in the current restaurant.

In addition, when obtaining the issued merchandise coupon matching the user identification, it can also be implemented through a preset filtering rule and matching algorithm For example, you can filter the merchandise coupon in the merchandise coupon database according to factors such as whether the coupon has been verified through other channels, whether the coupon is still within validity period, etc., so as to filter out the coupon that has expired or that has been cancelled after verification through other channels, therefore ensuring that the merchandise coupon pushed to the user is available.

Step S270: Obtain instance food information associated with the merchandise instance of the target merchandise coupon according to the instance-food association record stored in the merchandise coupon database, send to the user terminal the target merchandise coupon and the instance food information associated with the merchandise instance of the target merchandise coupon.

Since the merchandise coupon in this embodiment is generated based on the merchandise instance, at this step, first, determine the merchandise instance for generating the target merchandise coupon, specifically, the correspondence between merchandise coupon and merchandise instance are recorded in advance in the merchandise coupon database, correspondingly, according to the correspondence, the merchandise instance corresponding to the target merchandise coupon can be determined. Then, query the merchandise coupon database for the stored instance-food association record corresponding to the merchandise instance for generating the target merchandise coupon. Finally, according to the mapping relationship between merchandise instance stored in the queried instance-food association record and instance food information associated with the merchandise instance, obtain the instance food information associated with the merchandise instance of the target merchandise coupon.

Through the above method, for each target merchandise coupon, the instance food information associated with the merchandise instance of the target merchandise coupon can be obtained, and the obtained target merchandise coupon and its corresponding instance food information can be sent to the user terminal for the user terminal to select when ordering food.

In specific implementation, when the target merchandise coupon and the instance food information associated with the merchandise instance of the target merchandise coupon are sent to the user terminal, the target merchandise coupon and the instance food information associated with the merchandise instance of the target merchandise coupon are added to a food ordering page triggered by the food ordering request, which allows the user terminal to display the food ordering page; wherein the food ordering page is used to display the restaurant food list matching the restaurant identification included in the food ordering request. It can be seen that, in the method provided in this embodiment, the target merchandise coupon and the instance food information associated with the merchandise instance of the target merchandise coupon can be directly displayed on the food ordering page to achieve the purpose of ordering corresponding instance food information by performing a cancellation after verification on the target merchandise coupon when a user ordering food, thereby combining ordering food and cancellation after verification of merchandise coupon into one process, which is convenient for users.

In specific implementation, when the target merchandise coupon and the instance food information associated with the merchandise instance of the target merchandise coupon are added to the food ordering page triggered by the food ordering request, it can be implemented in either of the following two ways:

In the first implementation, the target merchandise coupon and the instance food information associated with the merchandise instance of the target merchandise coupon are directly displayed on the food ordering page at the same time. Correspondingly, a cancellation after verification entry element for the target merchandise coupon is set in vicinity of the target merchandise coupon, so that the user can perform a cancellation after verification on the target merchandise coupon through the cancellation after verification entry element. For example, take a burger package as the target merchandise coupon as an example, add a burger package merchandise coupon and its corresponding cancellation after verification entry element (specifically, it can be a check box) on the food ordering page, and the corresponding instance food information “a medium chicken burger, medium fries, and a medium coke” is directly displayed below the burger package merchandise coupon. This method displays the target merchandise coupon and the instance merchandise information at the same time, which is beneficial for users to order food quickly.

In the second implementation, firstly, each target merchandise coupon available to the user in the current restaurant is displayed on the food ordering page, and when the user views the target merchandise coupon, the corresponding instance food information is displayed. Specifically, the target merchandise coupon and a query entry element for the target merchandise coupon are added to the food ordering page; when a merchandise coupon query request triggered by the query entry element for the target merchandise coupon is received, the instance food information associated with the merchandise instance of the target merchandise coupon is displayed on the food ordering page, and the query entry element for the target merchandise coupon included in the food ordering page is replaced with the cancellation after verification entry element for the target merchandise coupon. In this method, only when the merchandise coupon query request sent through the query entry element for the target merchandise coupon by the user is received, the instance food information associated with the merchandise instance of the target merchandise coupon will be obtained and displayed. This method can quickly render the food ordering page before obtaining the instance food information, and the instance food information is obtained only when the merchandise coupon query request is received, so that ordering speed can be improved when the user does not want to use the merchandise coupon.

At step S280: When receiving a cancellation after verification request triggered by the user terminal for the target merchandise coupon, add the instance food information associated with the merchandise instance of the target merchandise coupon corresponding to the cancellation after verification request to an ordered food list of the user terminal.

In specific implementation, firstly, when the cancellation after verification request triggered by the cancellation after verification entry element for the target merchandise coupon included in the food ordering page is received, the target merchandise coupon corresponding to the cancellation after verification request is determined as a to-be-used merchandise coupon. Then, the acquired instance food information associated with the merchandise instance of the to-be-used merchandise coupon is determined as the to-be-coupon-paid food information. Finally, the to-be-coupon-paid food information is added to the ordered food list of the user terminal. In this way, an operation of performing a cancellation after verification on merchandise coupon can be realized directly on the food ordering page. For example, still taking the burger package merchandise coupon as an example, suppose the food ordering page includes the burger package merchandise coupon as well as other food such as “Little King Burger” and “Orange Juice”, accordingly, the user orders after ticking “Little King Burger” and “Orange Juice” on the food ordering page, and further ticks the cancellation after verification entry element for the burger package merchandise coupon, so the “Little King Burger”, the “Orange Juice” and the instance food information corresponding to the burger package merchandise coupon “a medium burger, medium fries, and a medium coke” are all added to the ordered food list of the user terminal.

At step S290: When receiving a food order submission request sent by the user terminal, perform a cancellation after verification on the target merchandise coupon corresponding to the cancellation after verification request according to the ordered food list.

In specific implementation, firstly, when receiving a food order submission request sent by the user terminal for the food ordering page, a to-be-paid food list corresponding to the food order submission request is determined according to the ordered food list. Among them, the to-be-paid food list is determined based on status of the ordered food list when the food order submission request is triggered. Since the ordered food list changes dynamically with ordering process, the to-be-paid food list is the ordered food list when submitting the food order submission request. Then, determine the to-be-coupon-paid food information included in the to-be-paid food list and the to-be-used merchandise coupon corresponding to the to-be-coupon-paid food information. Among them, the to-be-coupon-paid food information refers to content that matches the instance food information corresponding to the target merchandise coupon. In specific implementation, after receiving the cancellation after verification request triggered by the user terminal for the target merchandise coupon, the target merchandise coupon corresponding to the cancellation after verification request and its corresponding instance food information is recorded in backend, accordingly, query whether the to-be-paid food list includes content that matches the instance food information corresponding to the recorded target merchandise coupon, if so, the content that matches the instance food information corresponding to the recorded target merchandise coupon is determined as the to-be-coupon-paid food information. Finally, according to a received payment request triggered for the to-be-paid food list, perform a cancellation after verification on the to-be-used merchandise coupon corresponding to the to-be-coupon-paid food information included in the to-be-paid food list.

Specifically, according to the received payment request triggered for the to-be-paid food list, when performing a cancellation after verification on the to-be-used merchandise coupon corresponding to the to-be-coupon-paid food information included in the to-be-paid food list, based on the to-be-coupon-paid food information included in the to-be-paid food list, an order direct payment amount of the to-be-paid food list is calculated, according to the order direct payment amount, an order payment notification message is generated; according to the received payment request triggered for the order payment notification message, a cancellation after verification on the to-be-used merchandise coupon corresponding to the to-be-coupon-paid food information included in the to-be-paid food list is performed. Among them, the order direct payment amount refers to the amount corresponding to other ordered food in the to-be-paid food list than the to-be-coupon-paid food information. It can be seen that in this way, the amount that the user should actually pay after using the merchandise coupon can be automatically calculated, without cashier's manual confirmation, which avoids tedious and error-prone of manual confirmation.

Wherein, when performing a cancellation after verification on the to-be-used merchandise coupon corresponding to the to-be-coupon-paid food information included in the to-be-paid food list, the merchandise coupon in the merchandise coupon database that matches a coupon identification of the to-be-used merchandise coupon is queried, a cancellation after verification on the queried merchandise coupon is performed; in response to that the cancellation after verification is successful, the order total payment amount of the food order submission request is determined according to the order direct payment amount and the coupon payment amount of the to-be-used merchandise coupon. Account balance data in a restaurant account database corresponding to the restaurant identification is updated according to the order total payment amount.

In the above implementation, the user can trigger a cancellation after verification request by ticking the cancellation after verification entry element for the target merchandise coupon during the ordering process. After a server receives the cancellation after verification request, it will record relevant information of the to-be-used target merchandise coupon, and when it receives the food order submission request sent by the user, it will directly prompt user to pay amount of other foods except merchandise coupon. After the user has successfully paid, the recorded to-be-used target merchandise coupon will be automatically cancelled after verification. For the user, he/she does not need to separately perform a cancellation after verification on the merchandise coupon, just ticks the merchandise coupon during ordering process, so that ordering process and canceling after verifying process are completed at one time, and the user only need to pay amount of other foods except merchandise coupon, does not need pay twice, which provides convenience for him/her. For a merchant, in response to that the cancellation after verification is successful, the order total payment amount of the food order submission request is determined directly according to the order direct payment amount and the coupon payment amount of the to-be-used merchandise coupon, and the account balance data in the restaurant account database corresponding to the restaurant identification is updated according to the order total payment amount, so that the merchant can collect payment for this ordering operation at one time, performing a cancellation after verification on the merchandise coupon without perception, which provides convenience for the merchant.

FIG. 7 shows a schematic flowchart of canceling after verifying merchandise coupon during ordering process. As shown in FIG. 7, at step 3.1, a food ordering system receives a scanning table code request sent by a user terminal, that is, scanning-code ordering request; at step 3.2, the food ordering system queries a restaurant recipe according to the restaurant identification included in the food ordering request; at step 3.3, the food ordering system queries from the coupon system (i.e. the coupon database) the merchandise coupon available to the user in the current restaurant according to the user identification included in the food ordering request; at step 3.4, the food ordering system returns a food ordering page containing the recipe and the available merchandise coupon to the user terminal; at step 3.5, the user terminal clicks to use the merchandise coupon through a query entry element of the merchandise coupon; at step 3.6, the food ordering system queries dish (i.e. the instance food information) associated with the merchandise coupon from the merchandise system (i.e. the merchandise database); at step 3.7, the merchandise system returns a deductible dish corresponding to the merchandise coupon (i.e. the instance food information) to the food ordering system; at step 3.8, the user selects the dish corresponding to the merchandise coupon according to the deductible dish corresponding to the merchandise coupon, that is, verifies corresponding merchandise coupon through the cancellation after verification entry element; at step 3.9, the food ordering system submits order to an order system; at step 4.0, the order system guides the user to complete payment; at step 4.1, the order system sends a payment success notification to the coupon system; at step 4.2, the coupon system verifies corresponding merchandise coupon according to the payment success notification.

It can be seen that when a user goes to a restaurant to order food by scanning a code and open a restaurant menu page, a system will return to the user a merchandise coupon that can be used in the current restaurant according to the merchandise coupon under the user name and the dish in the current recipe corresponding to the merchandise coupon, through filtering rule and matching algorithm, present it as the dish in recipe for the user to choose. The user can tick the merchandise coupon to deduct applicable dishes. When the user chooses to use the merchandise coupon, the system queries and returns available dish information to the user. After the user selects the dish and submits an order, the system automatically calculates remaining amount that the user needs to pay. After user's payment is successful, the coupon system will jointly perform a cancellation after verification on the merchandise coupon ticked by the user according to notification of user's successful payment. Amount credited by a merchant includes sum of amount paid by a user who orders food and amount paid by the user when purchasing the merchandise coupon.

In summary, in this method, correspondence between merchandise coupons and instance food information as well as correspondences between merchandise coupons and user terminals are recorded in advance in a process of creating the merchandise coupons, so that the merchandise coupons can be automatically cancelled after verification based on the correspondences during the user ordering food by himself/herself, which eliminates tedious operation of manual check and cancellation after verification, combines ordering food and cancellation after verification of merchandise coupon into one process, and simplifies payment process and provides convenience for users. In addition, this method can automatically calculate a direct payment amount after the user uses the merchandise coupon, so that the user only needs to perform payment process once, and can update a restaurant database according to amount of merchandise coupon and user's direct payment amount, so that the restaurant completes collections without perception.

In traditional way of performing a cancellation after verification on a merchandise coupon, a cancellation after verification is performed based on a coupon code: when a user orders food in a restaurant, a merchant firstly confirms a dish applicable to the merchandise coupon offline, and then performs a cancellation after verification by inputting a coupon code of the merchandise coupon into a device or scanning a QR code generated based on the coupon code with the device. If the user consumes multiple dishes, the merchandise coupons need to be verified one by one for each dish, and additional amount that needs to be paid for remaining dishes needs to be calculated. Disadvantage of this cancellation after verification method is that, manual operation is necessary for confirming dishes to which each merchandise coupon is applicable, for performing cancellation after verifying one by one and for calculating reimbursement payment amount, which is very inconvenient. Method in the present disclosure can match a user-available merchandise coupon and applicable dishes of the merchandise coupons set by the merchant based on system backend, without need for offline confirmation by merchant. When the user chooses to place an order using the merchandise coupon, the system will automatically calculate additional amount that user needs to pay, without manual offline calculation. When the user pays successfully, the system will automatically perform a cancellation after verification on the merchandise coupons selected by the user, without cashier's offline verification one by one. This method can greatly improve the user's ordering experience, save labor cost for the merchant, and effectively combine an online-purchased coupon issued by the merchant with an offline ordering scene. Realizing combination of ordering food and performing cancellation after verification on merchandise not only avoids cumbersome process of verification and replenishment of coupons offline for merchants, but also improves users' ordering experience.

### Embodiment 3

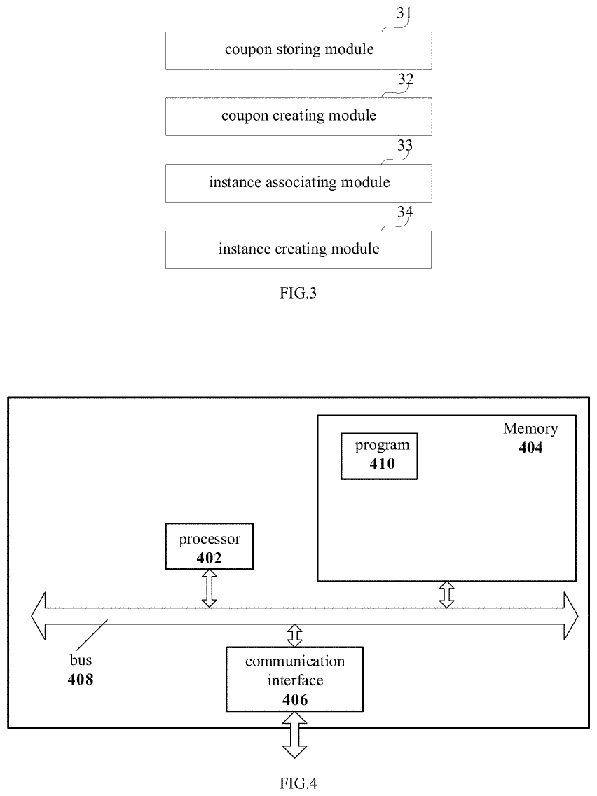

FIG. 3 shows a structural diagram of a device for issuing merchandise coupon of ordering food provided by the third embodiment of the present disclosure, the device includes:

An instance creating module 31 configured to create a merchandise instance for generating a merchandise coupon, and determine instance food information associated with the merchandise instance according to an obtained candidate food list for the merchandise instance;

An instance associating module 32 configured to store an association between merchandise instance and instance food information as an instance-food association record in a preset merchandise coupon database;

A coupon creating module 33 configured to create the merchandise coupon for the merchandise instance, and issue the created merchandise coupon to a user terminal;

A coupon storing module 34 configured to store a correspondence between issued merchandise coupon and user terminal receiving the merchandise coupon as a coupon-user association record in the merchandise coupon database, such that, when receiving a food ordering request from the user terminal, a cancellation after verification can be performed on the issued merchandise coupon according to the coupon-user association record and the instance-food association record stored in the merchandise coupon database.

Optionally, the instance creating module 31 is specifically configured to:

Determine a target restaurant to which the merchandise instance is applicable;

Obtain the candidate food list for the merchandise instance according to a restaurant food list of the target restaurant;

Determine the instance food information associated the merchandise instance according to a plurality of target foods selected from the candidate food list.

Optionally, the coupon creating module 33 is specifically configured to:

Generate a merchandise coupon template for the merchandise instance, and create the merchandise coupon for the merchandise instance according to the merchandise coupon template.

Optionally, the coupon creating module 33 is specifically configured to:

When receiving a merchandise coupon receiving request which is triggered by a user terminal via a merchandise coupon receiving entry displayed on a merchandise coupon receiving page, generate and send a coupon payment notification message corresponding to the merchandise coupon receiving request;

When receiving a coupon payment response message corresponding to the coupon payment notification message, issue the merchandise coupon corresponding to the merchandise coupon receiving request to the user terminal.

Optionally, the merchandise coupon database further comprises: a merchandise database and a coupon database;

The instance associating module 32 is configured to store the association between merchandise instance and instance food information as the instance-food association record in the preset merchandise database included in the preset merchandise coupon database;

In addition, the coupon storing module 34 is specifically configured to store the correspondence between issued merchandise coupon and user terminal receiving the merchandise coupon as the coupon-user association record in the coupon database included in the merchandise coupon database.

Optionally, the device further comprises:

An ordering and cancelling after verifying module configured to obtain a user identification included in the food ordering request when receiving a food ordering request sent by the user terminal; to obtain an issued merchandise coupon matching the user identification according to the coupon-user association record stored in the preset merchandise coupon database as a target merchandise coupon; to obtain instance food information associated with the merchandise instance of the target merchandise coupon according to the instance-food association record stored in the merchandise coupon database, and send to the user terminal the target merchandise coupon and the instance food information associated with the merchandise instance of the target merchandise coupon; when receiving a cancellation after verification request triggered by the user terminal for the target merchandise coupon, to add the instance food information associated with the merchandise instance of the target merchandise coupon corresponding to the cancellation after verification request to an ordered food list of the user terminal, so that when receiving the food order submission request sent by the user terminal, perform a cancellation after verification the target merchandise coupon corresponding to the cancellation after verification request according to the ordered food list.

Optionally, the ordering and cancelling after verifying module is specifically configured to:

Add the target merchandise coupon and the instance food information associated with the merchandise instance of the target merchandise coupon to a food ordering page triggered by the food ordering request, causing the user terminal to display the food ordering page;

Wherein, the food ordering page is configured to display a restaurant food list matching a restaurant identification included in the food ordering request.

Optionally, the ordering and cancelling after verifying module is specifically configured to:

Add the target merchandise coupon and a query entry element for the target merchandise coupon to the food ordering page;

When receiving a merchandise coupon query request which is triggered by the query entry element for the target merchandise coupon, display instance food information associated with the merchandise instance of the target merchandise coupon on the food ordering page, and replace the query entry element for the target merchandise coupon included on the food ordering page with a cancellation after verification entry element for the target merchandise coupon.

Optionally, the ordering and cancelling after verifying module is specifically configured to:

When receiving the cancellation after verification request triggered by a cancellation after verification entry element for the target merchandise coupon included on the food ordering page, determine the target merchandise coupon corresponding to the cancellation after verification request as a to-be-used merchandise coupon;

Then, determine the instance food information associated with the merchandise instance of the to-be-used merchandise coupon as to-be-coupon-paid food information;

Add the to-be-coupon-paid food information to the ordered food list of the user terminal.

Optionally, the ordering and cancelling after verifying module is specifically configured to:

When receiving a food order submission request sent by the user terminal for the food ordering page, determine a to-be-paid food list corresponding to the food order submission request according to the ordered food list;

Determine to-be-coupon-paid food information included in the to-be-paid food list and a to-be-used merchandise coupon corresponding to the to-be-coupon-paid food information;

Perform a cancellation after verification on the to-be-used merchandise coupon corresponding to the to-be-coupon-paid food information included in the to-be-paid food list according to a received payment request triggered for the to-be-paid food list.

Optionally, the ordering and cancelling after verifying module is specifically configured to:

calculate an order direct payment amount of the to-be-paid food list according to the to-be-coupon-paid food information included in the to-be-paid food list, generate an order payment notification message according to the order direct payment amount;

according to a received payment request triggered for the order payment notification message, perform a cancellation after verification on the to-be-used merchandise coupon corresponding to the to-be-coupon-paid food information included in the to-be-paid food list.

Optionally, the ordering and cancelling after verifying module is specifically configured to:

Query the merchandise coupon database for a merchandise coupon matching a coupon identification of the to-be-used merchandise coupon and perform a cancellation after verification on the queried merchandise coupon;

In response to that the cancellation after verification is successful, determine an order total payment amount of the food order submission request according to the order direct payment amount and a coupon payment amount of the to-be-used merchandise coupon;

According to the order total payment amount, update account balance data in a restaurant account database corresponding to the restaurant identification.

Optionally, the food ordering request further includes a restaurant identification, and the coupon-user association record includes: restaurant information to which respective issued merchandise coupons are applicable and a user identification of user terminal who has received respective merchandise coupons;

Optionally, the ordering and cancelling after verifying module is specifically configured to:

Select a coupon-user association record matching both the user identification and the restaurant identification included in the food ordering request from the merchandise coupon database according to the user identification and the restaurant identification included in the food ordering request;

Obtain an issued merchandise coupon matching the user identification according to the selected coupon-user association record.

Optionally, the ordering and cancelling after verifying module is specifically configured to:

Determine a merchandise instance for generating the target merchandise coupon;

Query the merchandise coupon database for a stored instance-food association record corresponding to the merchandise instance for generating the target merchandise coupon;

Obtain the instance food information associated with the merchandise instance of the target merchandise coupon according to a mapping relationship between merchandise instance stored in the queried instance-food association record and instance food information associated with the merchandise instance.

The specific structure and working principle of each of the above modules can be referred to the description in the corresponding part of the method embodiment, which will not be repeated here.

### Embodiment 4

The fourth embodiment of the present disclosure provides a non-volatile computer-readable storage medium having one or more executable instructions stored thereon. The computer-executable instructions can execute the method for issuing merchandise coupon of ordering food in any of the above method embodiments. The executable instructions may be specifically used to cause the processor to execute corresponding operations in the method embodiments as described above.

### Embodiment 5

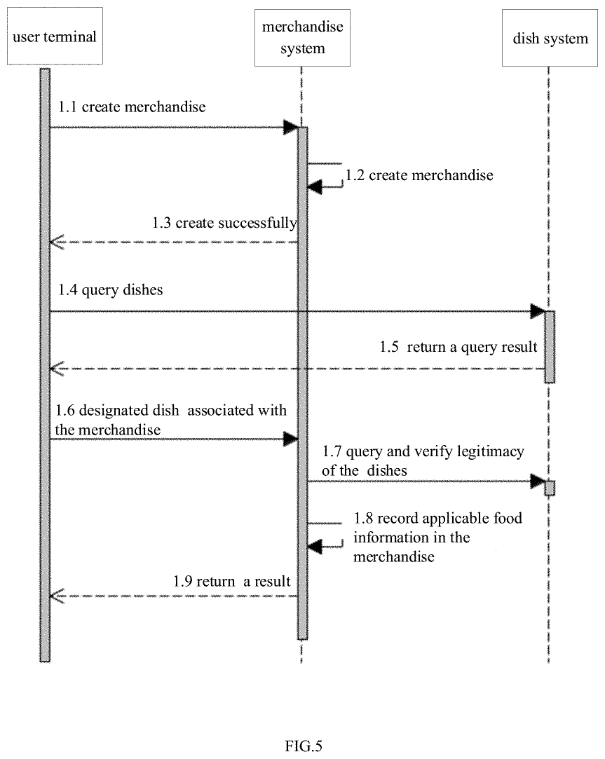

FIG. 4 shows a schematic structural diagram of an electronic device according to the fifth embodiment of the present disclosure. The specific embodiment of the present disclosure does not limit the specific implementation of the electronic device.

As shown in FIG. 4, the electronic device may include a processor 402, a communication interface 406, a memory 404, and a communication bus 408.

Where:

The processor 402, the communication interface 406, and the memory 404 communicate with each other through the communication bus 408.

The communication interface 406 is configured to communicate with other devices such as network elements of client devices, other servers or the like.

The processor 402 is configured to execute a program 410, and specifically can execute relevant steps in the embodiment of the method for issuing merchandise coupon of ordering food as described above.

Specifically, the program 410 may include program codes, and the program codes include computer operation instructions.

The processor 402 may be a Central Processing Unit CPU, or an Application Specific Integrated Circuit (ASIC), or one or more integrated circuits configured to implement the embodiments of the present disclosure. The one or more processors included in the electronic device may be the same type of processors, such as one or more CPUs, or different types of processors, such as one or more CPUs and one or more ASICs.

The memory 404 is configured to store the program 410. The memory 404 may include a high-speed RAM memory, and may further include a non-volatile memory, for example, at least one magnetic disk memory.

The program 410 may be specifically configured to enable the processor 402 to execute corresponding every operation in the above method embodiments

The algorithms and displays provided here are not inherently related to any particular computer, virtual system or other equipment. Various general-purpose systems can also be used based on the teachings herein. Based on the above description, the structure required to construct this type of system is obvious. In addition, the present disclosure is not directed to any specific programming language. It should be understood that various programming languages can be used to implement the contents of the present disclosure described herein, and the above description of a specific language is for the purpose of disclosing the best embodiment of the present disclosure.

In the specification provided here, a lot of specific details are explained. However, it can be understood that the embodiments of the present disclosure may be practiced without these specific details. In some instances, the well-known methods, structures, and technologies are not shown in detail, so as not to obscure the understanding of this specification.

Similarly, it should be understood that in order to simplify the present disclosure and help understand one or more of the various disclosed aspects, in the above description of the exemplary embodiments of the present disclosure, the various features of the present disclosure are sometimes grouped together into a single embodiment, drawing, or its description. However, the disclosed method should not be interpreted as reflecting the intention that the claimed disclosure requires more features than those explicitly recorded in each claim. More precisely, as reflected in the appended claims, the disclosure aspects lie in less than all features of a single embodiment previously disclosed. Therefore, the claims following the specific embodiments are thus explicitly incorporated into the specific embodiment, wherein each claim itself serves as a separate embodiment of the present disclosure.

Those skilled in the art can understand that it is possible to adaptively change the modules in the devices in the embodiments and set them in one or more devices different from the embodiments. The modules or units or components in the embodiments can be combined into one module or unit or component, and in addition, they can be divided into multiple sub-modules or sub-units or sub-components. Except that at least some of such features and/or processes or units are mutually exclusive, any combination can be used to combine all the features disclosed in this specification (including the appended claims, abstract and drawings) and all the processes or units of any method or device disclosed in this way. Unless expressly stated otherwise, each feature disclosed in this specification (including the appended claims, abstract and drawings) may be replaced by an alternative feature providing the same, equivalent or similar purpose.

In addition, those skilled in the art can understand that although some embodiments described herein include certain features included in other embodiments, but not other features, the combination of features in different embodiments means that they are within the scope of the present disclosure and form different embodiments. For example, in the following claims, any of the claimed embodiments can be used in any combination.

The various component embodiments of the present disclosure may be implemented by hardware, or by software modules running on one or more processors, or by a combination thereof Those skilled in the art should understand that a microprocessor or a digital signal processor (DSP) may be used in practice to implement some or all of the functions of some or all of the components in the voice input information-based lottery system according to the embodiments of the present disclosure. The present disclosure can also be implemented as a device or device program (for example, a computer program and a computer program product) for executing part or all of the methods described herein. Such a program for realizing the present disclosure may be stored on a computer-readable medium, or may have the form of one or more signals. Such signals can be downloaded from an Internet website, or provided on a signal carrier, or in any other form.

It should be noted that the above-mentioned embodiments illustrate rather than limit the present disclosure, and those skilled in the art can design alternative embodiments without departing from the scope of the appended claims. In the claims, any reference sign placed between parentheses should not be formed as a limitation to the claims. The word “consist of” does not exclude the presence of elements or steps not listed in the claims. The word “a” or “an” preceding an element does not exclude the presence of multiple such elements. The present disclosure can be realized by means of hardware including several different elements and by means of a computer appropriately programmed. In claims enumerating units of several devices, some of these devices may be embodied in the same hardware item. The use of the words “first,” “second,” and “third,” etc. does not indicate any order. These words can be interpreted as names.

1. A method for issuing merchandise coupon of ordering food, comprising:
creating a merchandise instance for generating a merchandise coupon;
determining instance food information associated with the merchandise instance according to an obtained candidate food list for the merchandise instance;
storing an association between merchandise instance and instance food information as an instance-food association record in a preset merchandise coupon database;
creating the merchandise coupon for the merchandise instance;
issuing the created merchandise coupon to a user terminal;
storing a correspondence between issued merchandise coupon and user terminal receiving the merchandise coupon as a coupon-user association record in the merchandise coupon database, such that, when receiving a food ordering request from the user terminal, a cancellation after verification can be performed on the issued merchandise coupon according to the coupon-user association record and the instance-food association record stored in the merchandise coupon database.

2. The method according to claim 1, wherein, the determining instance food information associated with the merchandise instance according to an obtained candidate food list for the merchandise instance specifically comprises:
determining a target restaurant to which the merchandise instance is applicable;
obtaining the candidate food list for the merchandise instance according to a restaurant food list of the target restaurant;
determining the instance food information associated with the merchandise instance according to a plurality of target foods selected from the candidate food list.

3. The method according to claim 1 or 2, wherein the creating the merchandise coupon for the merchandise instance specifically comprises:
generating a merchandise coupon template for the merchandise instance, and
creating the merchandise coupon for the merchandise instance according to the merchandise coupon template.

4. The method according to any of claims 1 to 3, wherein the issuing the created merchandise coupon to a user terminal specifically comprises:
when receiving a merchandise coupon receiving request which is triggered by a user terminal via a merchandise coupon receiving entry displayed on a merchandise coupon receiving page, generating and sending a coupon payment notification message corresponding to the merchandise coupon receiving request;
when receiving a coupon payment response message corresponding to the coupon payment notification message, issuing the merchandise coupon corresponding to the merchandise coupon receiving request to the user terminal.

5. The method according to any of claims 1 to 4, wherein the merchandise coupon database further comprises a merchandise database and a coupon database;
then, the storing an association between merchandise instance and instance food information as an instance-food association record in a preset merchandise coupon database comprises: storing the association between merchandise instance and instance food information as the instance-food association record in the merchandise database included in the preset merchandise coupon database;
and, the storing a correspondence between issued merchandise coupon and user terminal receiving the merchandise coupon as a coupon-user association record in the merchandise coupon database comprises: storing the correspondence between issued merchandise coupon and user terminal receiving the merchandise coupon as the coupon-user association record in the coupon database included in the merchandise coupon database.

6. The method according to any of claims 1 to 5, wherein, when receiving a food ordering request from the user terminal, performing a cancellation after verification on the issued merchandise coupon according to the coupon-user association record and the instance-food association record stored in the merchandise coupon database comprises:
when receiving a food ordering request sent by the user terminal, obtaining a user identification included in the food ordering request;
obtaining an issued merchandise coupon matching the user identification according to the coupon-user association record stored in the preset merchandise coupon database as a target merchandise coupon;
obtaining instance food information associated with the merchandise instance of the target merchandise coupon according to the instance-food association record stored in the merchandise coupon database;
sending to the user terminal the target merchandise coupon and the instance food information associated with the merchandise instance of the target merchandise coupon;
when receiving a cancellation after verification request triggered by the user terminal for the target merchandise coupon, adding the instance food information associated with the merchandise instance of the target merchandise coupon corresponding to the cancellation after verification request to an ordered food list of the user terminal, so that when receiving a food order submission request sent by the user terminal, performing a cancellation after verification on the target merchandise coupon corresponding to the cancellation after verification request according to the ordered food list.

7. The method according to claim 6, wherein the sending to the user terminal the target merchandise coupon and the instance food information associated with the merchandise instance of the target merchandise coupon comprises:
adding the target merchandise coupon and the instance food information associated with the merchandise instance of the target merchandise coupon to a food ordering page triggered by the food ordering request, causing the user terminal to display the food ordering page;
wherein, the food ordering page is configured to display a restaurant food list matching a restaurant identification included in the food ordering request.

8. The method according to claim 7, wherein the adding the target merchandise coupon and the instance food information associated with the merchandise instance of the target merchandise coupon to a food ordering page triggered by the food ordering request comprises:
adding the target merchandise coupon and a query entry element for the target merchandise coupon to the food ordering page;
when receiving a merchandise coupon query request which is triggered by the query entry element for the target merchandise coupon,
displaying the instance food information associated with the merchandise instance of the target merchandise coupon on the food ordering page, and
replacing the query entry element for the target merchandise coupon included on the food ordering page with a cancellation after verification entry element for the target merchandise coupon.

9. The method according to any of claims 6 to 8, wherein, when receiving a cancellation after verification request triggered by the user terminal for the target merchandise coupon, adding the instance food information associated with the merchandise instance of the target merchandise coupon corresponding to the cancellation after verification request to the ordered food list of the user terminal comprises:
when receiving the cancellation after verification request triggered by a cancellation after verification entry element for the target merchandise coupon included on the food ordering page, determining the target merchandise coupon corresponding to the cancellation after verification request as a to-be-used merchandise coupon;
determining the instance food information associated with the merchandise instance of the to-be-used merchandise coupon as to-be-coupon-paid food information;
adding the to-be-coupon-paid food information to the ordered food list of the user terminal.

10. The method according to claim 9, wherein, when receiving a food order submission request sent by the user terminal, performing a cancellation after verification on the target merchandise coupon corresponding to the cancellation after verification request according to the ordered food list comprises:
when receiving a food order submission request sent by the user terminal for the food ordering page, determining a to-be-paid food list corresponding to the food order submission request according to the ordered food list;
determining to-be-coupon-paid food information included in the to-be-paid food list and a to-be-used merchandise coupon corresponding to the to-be-coupon-paid food information;
performing a cancellation after verification on the to-be-used merchandise coupon corresponding to the to-be-coupon-paid food information included in the to-be-paid food list according to a received payment request triggered for the to-be-paid food list.

11. The method according to claim 10, wherein, the performing a cancellation after verification on the to-be-used merchandise coupon corresponding to the to-be-coupon-paid food information included in the to-be-paid food list according to a received payment request triggered for the to-be-paid food list specifically comprises:
calculating an order direct payment amount of the to-be-paid food list according to the to-be-coupon-paid food information included in the to-be-paid food list;
generating an order payment notification message according to the order direct payment amount;
according to a received payment request triggered for the order payment notification message, performing a cancellation after verification on the to-be-used merchandise coupon corresponding to the to-be-coupon-paid food information included in the to-be-paid food list.

12. The method according to claim 11, wherein the performing a cancellation after verification on the to-be-used merchandise coupon corresponding to the to-be-coupon-paid food information included in the to-be-paid food list specifically comprises:
querying the merchandise coupon database for a merchandise coupon matching a coupon identification of the to-be-used merchandise coupon;
performing a cancellation after verification on the queried merchandise coupon;
in response to that the cancellation after verification is successful, determining an order total payment amount of the food order submission request according to the order direct payment amount and a coupon payment amount of the to-be-used merchandise coupon;
according to the order total payment amount, updating account balance data in a restaurant account database corresponding to the restaurant identification.

13. The method according to any of claims 6 to 12, wherein the food ordering request further comprises a restaurant identification, and the coupon-user association record comprises restaurant information to which respective issued merchandise coupons are applicable and a user identification of user terminal who has received respective merchandise coupons; then the obtaining an issued merchandise coupon matching the user identification according to the coupon-user association record stored in the preset merchandise coupon database comprises:
according to the user identification and the restaurant identification included in the food ordering request, selecting a coupon-user association record matching both the user identification and the restaurant identification included in the food ordering request from the merchandise coupon database;
according to the selected coupon-user association record, obtaining an issued merchandise coupon matching the user identification.

14. The method according to any of claims 6 to 13, wherein the obtaining instance food information associated with the merchandise instance of the target merchandise coupon according to the instance-food association record stored in the merchandise coupon database comprises:
determining a merchandise instance for generating the target merchandise coupon;
querying the merchandise coupon database for a stored instance-food association record corresponding to the merchandise instance for generating the target merchandise coupon;
according to a mapping relationship between merchandise instance stored in the queried instance-food association record and instance food information associated with the merchandise instance, obtaining the instance food information associated with the merchandise instance of the target merchandise coupon.

15. A device for issuing merchandise coupon of ordering food, comprising:
an instance creating module configured to create a merchandise instance for generating a merchandise coupon, and determine instance food information associated with the merchandise instance according to an obtained candidate food list for the merchandise instance;
an instance associating module configured to store an association between merchandise instance and instance food information as an instance-food association record in a preset merchandise coupon database;
a coupon creating module configured to create the merchandise coupon for the merchandise instance, and issue the created merchandise coupon to a user terminal;
a coupon storing module configured to store a correspondence between issued merchandise coupon and user terminal receiving the merchandise coupon as a coupon-user association record in the merchandise coupon database, such that, when receiving a food ordering request from the user terminal, a cancellation after verification can be performed on the issued merchandise coupon according to the coupon-user association record and the instance-food association record stored in the merchandise coupon database.

16. The device according to claim 15, wherein the instance creating module is specifically configured to:
determine a target restaurant to which the merchandise instance is applicable;
obtain the candidate food list for the merchandise instance according to a restaurant food list of the target restaurant;
determine the instance food information associated the merchandise instance according to a plurality of target foods selected from the candidate food list.

17. The device according to claim 15 or 16, wherein the coupon creating module is specifically configured to:
generate a merchandise coupon template for the merchandise instance, and
create the merchandise coupon for the merchandise instance according to the merchandise coupon template.

18. The device according to any of claims 15 to 17, wherein the coupon creating module is specifically configured to:
when receiving a merchandise coupon receiving request which is triggered by a user terminal via a merchandise coupon receiving entry displayed on a merchandise coupon receiving page, generate and send a coupon payment notification message corresponding to the merchandise coupon receiving request;
when receiving a coupon payment response message corresponding to the coupon payment notification message, issue the merchandise coupon corresponding to the merchandise coupon receiving request to the user terminal.

19. The device according to any of claims 15 to 18, wherein the merchandise coupon database further comprises: a merchandise database and a coupon database;
then the instance associating module is configured to store the association between merchandise instance and instance food information as the instance-food association record in the preset merchandise database included in the preset merchandise coupon database;
and, the coupon storing module is specifically configured to store the correspondence between issued merchandise coupon and user terminal receiving the merchandise coupon as the coupon-user association record in the coupon database included in the merchandise coupon database.

20. The device according to any of claims 15 to 19, wherein the device further comprises:
an ordering and cancelling after verifying module configured to:
obtain a user identification included in the food ordering request when receiving a food ordering request sent by the user terminal;
obtain an issued merchandise coupon matching the user identification according to the coupon-user association record stored in the preset merchandise coupon database as a target merchandise coupon;
obtain instance food information associated with the merchandise instance of the target merchandise coupon according to the instance-food association record stored in the merchandise coupon database;
send to the user terminal the target merchandise coupon and the instance food information associated with the merchandise instance of the target merchandise coupon;
when receiving a cancellation after verification request triggered by the user terminal for the target merchandise coupon, add the instance food information associated with the merchandise instance of the target merchandise coupon corresponding to the cancellation after verification request to an ordered food list of the user terminal, so that when receiving the food order submission request sent by the user terminal, perform a cancellation after verification on the target merchandise coupon corresponding to the cancellation after verification request according to the ordered food list.

21. The device according to claim 20, wherein the ordering and cancelling after verifying module is specifically configured to:
add the target merchandise coupon and the instance food information associated with the merchandise instance of the target merchandise coupon to a food ordering page triggered by the food ordering request, causing the user terminal to display the food ordering page;
wherein, the food ordering page is configured to display a restaurant food list matching a restaurant identification included in the food ordering request.

22. The device according to claim 21, wherein the ordering and cancelling after verifying module is specifically configured to:
add the target merchandise coupon and a query entry element for the target merchandise coupon to the food ordering page;
when receiving a merchandise coupon query request which is triggered by the query entry element for the target merchandise coupon,
display the instance food information associated with the merchandise instance of the target merchandise coupon on the food ordering page, and
replace the query entry element for the target merchandise coupon included on the food ordering page with a cancellation after verification entry element for the target merchandise coupon.

23. The device according to any of claims 20 to 22, wherein the ordering and cancelling after verifying module is specifically configured to:
when receiving the cancellation after verification request triggered by a cancellation after verification entry element for the target merchandise coupon included on the food ordering page, determine the target merchandise coupon corresponding to the cancellation after verification request as a to-be-used merchandise coupon;
determine the instance food information associated with the merchandise instance of the to-be-used merchandise coupon as to-be-coupon-paid food information;
add the to-be-coupon-paid food information to the ordered food list of the user terminal.

24. The device according to claim 23, wherein the ordering and cancelling after verifying module is specifically configured to:
when receiving a food order submission request sent by the user terminal for the food ordering page, determine a to-be-paid food list corresponding to the food order submission request according to the ordered food list;
determine to-be-coupon-paid food information included in the to-be-paid food list and a to-be-used merchandise coupon corresponding to the to-be-coupon-paid food information;
perform a cancellation after verification on the to-be-used merchandise coupon corresponding to the to-be-coupon-paid food information included in the to-be-paid food list according to a received payment request triggered for the to-be-paid food list.

25. The device according to claim 24, wherein the ordering and cancelling after verifying module is specifically configured to:
calculate an order direct payment amount of the to-be-paid food list according to the to-be-coupon-paid food information included in the to-be-paid food list;
generate an order payment notification message according to the order direct payment amount;
according to a received payment request triggered for the order payment notification message, perform a cancellation after verification on the to-be-used merchandise coupon corresponding to the to-be-coupon-paid food information included in the to-be-paid food list.

26. The device according to claim 25, wherein the ordering and cancelling after verifying module is specifically configured to:
query the merchandise coupon database for a merchandise coupon matching a coupon identification of the to-be-used merchandise coupon;
perform a cancellation after verification on the queried merchandise coupon;
in response to that the cancellation after verification is successful, determine an order total payment amount of the food order submission request according to the order direct payment amount and a coupon payment amount of the to-be-used merchandise coupon;
according to the order total payment amount, update account balance data in a restaurant account database corresponding to the restaurant identification.

27. The device according to any of claims 20 to 26, wherein the food ordering request further comprises a restaurant identification, and the coupon-user association record comprises restaurant information to which respective issued merchandise coupons are applicable and a user identification of user terminal who has received respective merchandise coupons;
then the ordering and cancelling after verifying module is specifically configured to:
according to the user identification and the restaurant identification included in the food ordering request, select a coupon-user association record matching both the user identification and the restaurant identification included in the food ordering request from the merchandise coupon database;
according to the selected coupon-user association record, obtain an issued merchandise coupon matching the user identification.

28. The device according to claims 20 to 27, wherein the ordering and cancelling after verifying module is specifically configured to:
determine a merchandise instance for generating the target merchandise coupon;
query the merchandise coupon database for a stored instance-food association record corresponding to the merchandise instance for generating the target merchandise coupon;
according to a mapping relationship between merchandise instance stored in the queried instance-food association record and instance food information associated with the merchandise instance, obtain the instance food information associated with the merchandise instance of the target merchandise coupon.

29. An electronic device, comprising: a processor, a memory, a communication interface, and a communication bus, wherein the processor, the memory, and the communication interface communicate with each other through the communication bus;
the memory is configured to store one or more executable instructions, and the executable instructions cause the processor to execute corresponding operations in a method for issuing merchandise coupon of ordering food according to any of claims 1 to 14.

30. A non-volatile computer-readable storage medium having one or more executable instructions stored thereon, wherein the executable instructions cause a processor to execute corresponding operations in the method for issuing merchandise coupon of ordering food according to any of claims 1 to 14.

31. A computer program product, comprising: a computer program stored on a non-volatile computer storage medium; the computer program comprises program instructions; and when the program instructions are executed by a processor, the processor is caused to execute corresponding operations in a method for issuing merchandise coupon of ordering food according to any of claims 1 to 14.
